(19) United States
(12) Patent Application Publication
(10) Pub. No.: US 2005/0056512 A1
(43) Pub. Date: Mar. 17, 2005

(54) Hydrodynamic torque converter

(75) Inventors: Christoph Sasse, Schweinfurt (DE); Jorg Sudau, Niederwerrn (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 10/928,818

(22) Filed: Aug. 25, 2004

(30) Foreign Application Priority Data
Sep. 17, 2003 (DE) 103 42 898.4

(51) Int. Cl. F16H 45/02

(52) U.S. Cl. 192/3.3; 192/70.12; 192/113.36

(57) ABSTRACT

A hydrodynamic torque converter comprising a housing arrangement (18), which can be filled with working fluid; a pump wheel (30); a turbine wheel (26), which is mounted in the housing arrangement (18) with freedom to rotate with respect to the housing around an axis of rotation (A); and a bridging clutch arrangement (50) for a torque-transmitting connection between the housing arrangement (18) and the turbine wheel (26). The bridging clutch (58) may have at least one first friction element (60, 62), which can rotate together with the housing arrangement (18), and at least one second friction element (64, 66), which can rotate together with the turbine wheel (26), which friction elements can be brought into frictional contact with each other to provide the torque-transmitting connection, where at least one of the friction elements (60, 62, 64, 66) is designed to produce a fluid circulation (Z), which flows around at least certain areas of the friction elements (60, 62, 64, 66).

### CROSS REFERENCE TO RELATED APPLICATIONS

Priority is claimed for this application under 35 U.S.C. § 119 to German application No. 103 42 898.4 filed Sep. 17, 2003.

### FIELD OF THE INVENTION

The present invention pertains to a hydrodynamic torque converter, comprising a housing arrangement, which is or can be filled with working fluid; a pump wheel; a turbine wheel, which is mounted in the housing arrangement and which can rotate with respect to the housing around an axis of rotation; and a bridging clutch arrangement for the optional provision of a torque-transmitting connection between the housing arrangement and the turbine wheel, where the bridging clutch arrangement has at least one first friction element which can rotate together with the housing arrangement and at least one second friction element which can rotate together with the turbine wheel, which friction elements can be brought into frictional contact with each other to provide the torque-transmitting connection.

### BACKGROUND OF THE INVENTION

In these types of hydrodynamic torque converters, the bridging clutch works during certain operating phases in such a way that the slip still present between the housing arrangement and the turbine wheel despite the frictional contact between the various friction elements produces a power loss. This lost power is carried away in the form of thermal energy. That is, the heat created in the area of the friction elements as a result of their frictional interaction is given off to the working fluid present in the housing arrangement. Especially when the slippage is prolonged, the frictional interaction present between the friction elements can cause the elements to heat excessively. The primary reason for this is that the flow of the fluid which passes around the friction elements to absorb heat from them is limited by the fluid exchange present during the operation of the converter. Especially in hydrodynamic torque converters of the so-called three-line type, this limitation is critical, because, even though there may be some exchange of fluid, there is nothing to guarantee that the fluid will be forced to flow around the friction elements in a defined manner.

The task of the present invention is to design a hydrodynamic torque converter of the basic type indicated above in such a way that the power loss which can be produced in the area of the bridging clutch arrangement can be increased without the danger of damage to the components of that clutch.

This task is accomplished in accordance with the teachings of the present invention by a hydrodynamic torque converter comprising a housing arrangement, which is or can be filled with working fluid; a pump wheel; a turbine wheel, which is mounted in the housing arrangement and which can rotate with respect to the housing around an axis of rotation; and a bridging clutch arrangement for the optional provision of a torque-transmitting connection between the housing arrangement and the turbine wheel, where the bridging clutch arrangement has at least one first friction element which can rotate together with the housing arrangement and at least one second friction element which can rotate together with the turbine wheel, which friction elements can be brought into frictional contact with each other to provide the torque-transmitting connection, where at least one of the friction elements is designed to produce a fluid circulation which flows around at least certain areas of the friction elements.

By designing a hydrodynamic torque converter in the area of its bridging clutch arrangement in such a way that a fluid circulation which flows around the friction elements is generated at least when slip is present between the first and second friction elements, it is possible to make available an additional cooling function, produced by this fluid flow. Because the fluid flow is built up in a defined manner in the area which is subjected to especially high thermal load, primarily during the time that the clutch is slipping, the heat can be dissipated from the area of the friction elements in a highly efficient manner.

A fluid transport arrangement can, for example, be provided on at least one of the friction elements to generate the fluid circulation. The fluid transport arrangement can comprise at least one fluid transport surface.

In an embodiment which is of very simple design but is very efficient at the same time, it is possible for at least one of the friction elements to comprise a friction lining carrier and a friction lining arrangement carried thereon, and for the minimum of one fluid transport surface to be provided by the friction lining arrangement. For this purpose, it is possible, for example, for the friction lining arrangement on at least one side of the friction lining carrier to have a plurality of friction lining segments arranged in a row in the circumferential direction, and for at least one fluid transport surface to be provided by a circumferentially-facing end surface of a friction lining segment. Alternatively or in addition, it is possible for the friction lining arrangement to have at least one groove-like fluid flow channel extending radially inward from the radially outward area and for at least one fluid transport surface to be provided by a circumferentially-facing wall forming one of the boundaries of the minimum of one fluid flow channel. An especially efficient circulating flow in the entire area of the frictionally interacting assemblies can be achieved by arranging first and second friction elements alternately in the axial direction, which first and second friction elements each have a friction lining arrangement on one axial side, where the friction lining arrangements of the first friction elements and the friction lining arrangements of the second friction elements provide the fluid transport surfaces.

In accordance with another advantageous aspect, the hydrodynamic torque converter can be designed in such a way that an actuating piston arrangement is provided, by means of which the first and second friction elements can be brought into frictional contact with each other, and so that the actuating piston arrangement divides an interior space of the housing arrangement into a first space, which contains the turbine wheel, and a second space, to which pressurized fluid can be supplied to displace the piston, where the first space and the second space are not in fluid-exchanging connection with each other. The pressurized fluid for actuating the piston arrangement can be supplied essentially independently of the fluid exchange of the working fluid present in the first space of the housing arrangement. In a hydrodynamic torque converter designed in this way, it is especially advantageous that the circulation flowing around the friction elements according to the invention is produced by means of the appropriate design of the friction elements themselves.

### BRIEF DESCRIPTION OF THE FIGURES

The present invention is described in detail below on the basis of the attached drawings:

FIG. 1 shows a partial longitudinal cross section through an inventive hydrodynamic torque converter; and

FIG. 2 shows a partial axial view of a first friction element used in the torque converter according to FIG. 1.

### DETAILED DESCRIPTION OF THE PREFERRED EMBODIMENTS

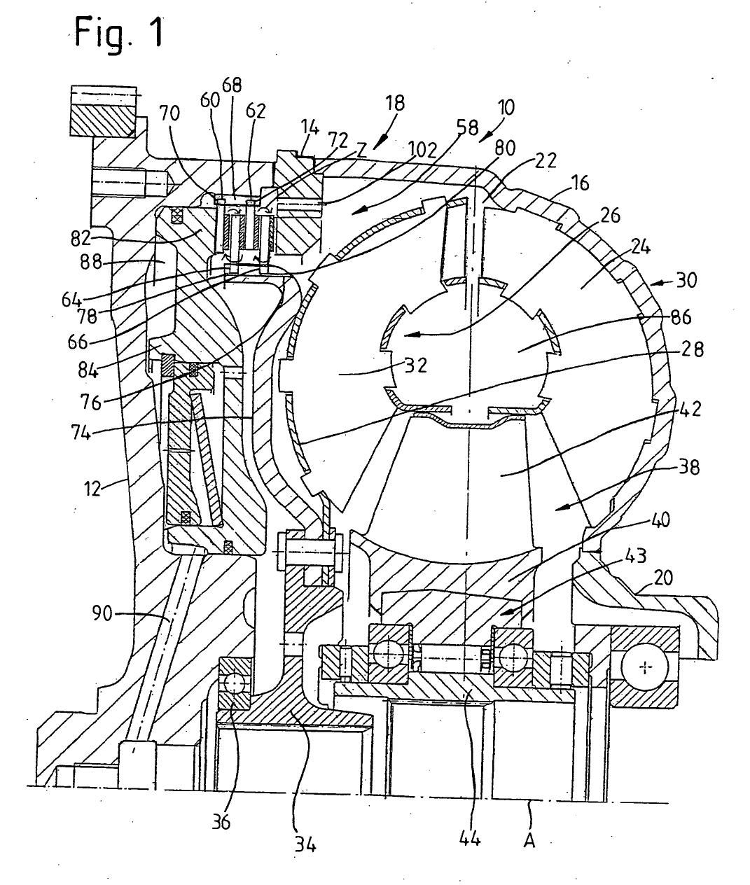

FIG. 1 shows a hydrodynamic torque converter, designated overall by the number 10. This converter comprises a housing cover 12, the radially outer area of which is permanently connected to an abutment ring 14, to be described in greater detail below, by means of welds, for example, especially laser welds. On the other axial side—relative to an axis of rotation A of the overall system—a pump wheel shell 16 is connected to this abutment ring 14. These components 12, 14, 16 form the essential components of a housing arrangement, designated overall by the number 18, of the hydrodynamic torque converter 10. The pump wheel shell 16 is also permanently connected in its radially inner area to a pump wheel hub 20 by means of welds, for example. In the exemplary embodiment shown, the housing cover 14 is a casting, as is the abutment ring 14. The pump wheel shell 16 is shaped from a piece of sheet metal.

On the side facing an interior space 22 of the housing arrangement 18, the pump wheel shell 16 carries a plurality of pump wheel vanes 14, which follow each other in the circumferential direction around the axis of rotation A. A turbine wheel, designated overall by the number 26, is also provided in the interior space 22. This wheel comprises a turbine wheel shell 28, which, on the side facing the pump wheel 30, consisting essentially of the pump wheel shell 16 and the pump wheel vanes 24, carries a plurality of turbine wheel vanes 32. Radially on the inside, the turbine wheel shell 28 is permanently connected—in the present case by rivets—to a turbine wheel hub 34. It would also be possible to provide here a connection by way of a torsional vibration damper, for example. The radially inner area of the turbine wheel hub 34 is designed in turn to be connected nonrotatably to a power takeoff shaft, such as a gearbox input shaft. The turbine wheel hub 34, furthermore, is mounted with freedom of rotation in a bearing 36 on the housing cover 12 and is also supported axially against it.

A stator, designated overall by the number 38, is provided between the pump wheel 30 and the turbine wheel 28. The stator comprises a plurality of stator vanes 42, arranged in the circumferential direction around an outer stator ring 40 between the axially inner end areas of the pump wheel vanes 24 and of the turbine wheel vanes 32. The outer stator ring 40 is carried by way of a freewheel arrangement 43 (indicated only schematically) on an inner stator ring 44, which is supported nonrotatably on a support element such as a hollow support shaft or the like. The stator vanes 42 can thus rotate along with the outer stator ring 40 in only one circumferential direction around the axis of rotation.

The hydrodynamic torque converter 10 comprises a bridging clutch arrangement, designated overall by the number 58. This arrangement serves, in various operating states, to introduce at least some of the torque being transmitted from a drive unit to a shaft, such as a gearbox input shaft, directly to the turbine wheel 26 by a mechanical, friction-locking connection with the housing arrangement 18.

In the case illustrated here, the bridging clutch arrangement 58 comprises two first friction elements 60, 62, which are connected nonrotatably to the housing arrangement 18, namely, to the housing cover 12 thereof. For this purpose, the housing cover 12 has a set of internal teeth 68 on an axial section of the cover; sets of external teeth 70, 72 on the friction elements 60, 62 engage circumferentially with these internal teeth. Two second friction elements 64, 66 are also provided. These are offset from, or alternate in the axial direction with respect to, the first friction elements 60, 62 and are connected nonrotatably via a disk-like driver element 74 to the turbine wheel 26. This driver element 74 has on its outer circumferential area a set of teeth 76, with which the sets of teeth 78, 80 of the friction elements 64, 66 are in circumferential engagement. Both the first friction elements 60, 62 and the second friction elements 64, 66 are connected nonrotatably to the components which carry them along in the circumferential direction, namely, to the housing cover 12 and to the driver element 74, respectively, but are nevertheless still capable of a certain axial movement with respect to these components.

The abutment ring 14 lies on one axial side of the friction elements 60, 62, 64, 66; in particular, it is axially adjacent to the friction element 66 connected nonrotatably to the turbine wheel 26. On the other axial side of the friction element stack, there is an actuating area 82 of a clutch piston, designated overall by the number 84. This clutch piston 84 is held in a fluid-tight manner but with freedom of axial movement in a ring-like recess in the housing cover 12, so that the interior space 22 of the housing arrangement 12 is divided into two spaces 86, 88. The turbine wheel 26 is accommodated in the space 86, whereas several fluid channels 90 lead into the space 88. Via these fluid channels and, for example, a central bore in the power takeoff shaft (not shown), it is possible for pressurized fluid to enter the space 88, so that, by increasing the fluid pressure in this space 88 so that it is higher than the pressure in the space 86, it is possible to produce an actuating force which moves the clutch piston 84 toward the abutment ring 14. When sufficient force is exerted on the clutch piston 84, this piston presses against the friction element 60, which is connected nonrotatably to the housing arrangement 18 and thus also to the clutch piston 84. Friction element 60 presses against the friction element 64. This friction element 64 presses against the friction element 62, which in turn presses against the friction element 66. The friction element 66 is ultimately supported against the abutment ring 14 and thus against the housing arrangement 18. In this way, four frictionally interacting pairs of surfaces are created, namely, that between the friction element 60 and the friction element 64, that between the friction element 64 and the friction element 62, that between the friction element 62 and the friction element 66, and that between the friction element 66 and the abutment ring 14.

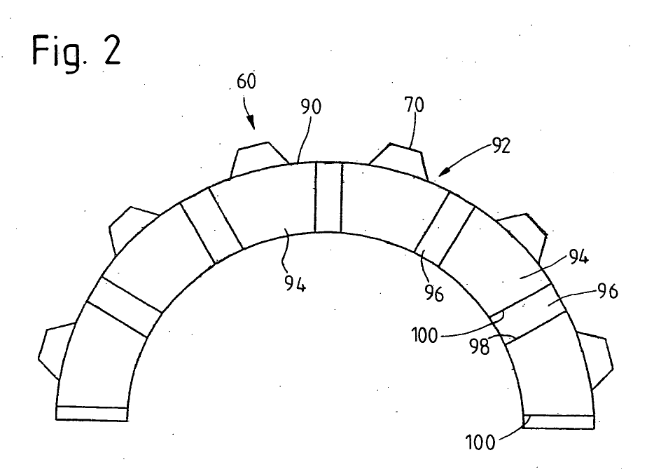

In these types of hydrodynamic torque converters 10 of the three-line type, in which, therefore, the pressurized fluid required to actuate the clutch piston 84 is supplied via a separate line to the space 88, the working fluid present in the space 86 is supplied and discharged via feed and discharge areas specifically provided on either side of the stator 38. There is in practice no fluid exchange between the spaces 86 and 88. Another result of this design is that, in spite of the fluid exchange occurring in the space 86, there is only a very limited amount of circulation around the frictionally active surface areas of the friction elements 60, 62, 64, 66. To deal with the problem of the overheating of the friction elements 60, 62, 64, 66 when the clutch is slipping, as will be explained in the following, these friction elements 60, 62, 64, 66 are designed so that they generate their own fluid circulation Z, as indicated by the small arrows in FIG. 1, which flows around the friction elements 60, 62, 64, 66. This is explained in the following with reference to FIG. 2, which represents by way of example the friction element 60. The following description offered on the basis of friction element 60 applies equally to the other friction elements 62, 64, 66, with the difference that, in the case of the friction elements 64, 66, the previously discussed sets of teeth 78, 80 are located on the inner circumferential side.

It can be seen in FIGS. 1 and 2 that the friction element 60, and in a corresponding manner, the other friction elements 62, 64, 66 as well, have a ring-like friction lining carrier 90 made, for example, of stamped sheet metal. This carrier carries the set of teeth 70 in its outer circumferential area. On one axial side, the friction lining carrier 90 carries a friction lining arrangement 92. In the case illustrated here, this arrangement comprises a plurality of friction lining segments 94, arranged in a row in the circumferential direction with a certain circumferential gap between them. As a result of the circumferential gap between the friction lining segments 94, channel-like intermediate spaces 96 are formed between them. These spaces form channel-like passages extending radially outward from the radially inner area. In the circumferential direction, these channels 96 are bounded by circumferentially-facing end surfaces 98, 100 of the friction lining segments 94. Because the various friction elements 60, 62, 64, 66 each have this type of friction lining arrangement 92 on only one axial side of the friction lining carrier 90, the arrangement which can be seen in FIG. 1 is obtained in which, in each case, a friction lining arrangement 92 on one of the friction elements can be brought into contact with a friction lining carrier 90 of the friction element following immediately after it in the axial direction and thus enter into frictional interaction with it. Through the suitable choice of material for the friction lining arrangements 92, it is possible here to obtain an appropriately defined friction ratio for the defined frictional contact between the friction lining and the friction lining carrier.

When the first friction elements 60, 62 rotate with respect to the second friction elements 64, 66, that is, when the bridging clutch arrangement 58 is slipping, the first friction elements 60, 62 will usually be rotating faster than the second friction elements 64, 66. This has the result that the fluid present in the faster-rotating friction elements 60, 62, i.e., in the areas of the channels 96 in those elements, is carried along faster in the circumferential direction by the circumferentially-facing end surfaces 98 or 100 (depending on the direction of rotation) and thus exposed to stronger centrifugal forces than the fluid in the second friction elements 64, 66, which are rotating more slowly. The circumferentially-facing end surfaces 98, 100 of the friction elements 60, 62 thus represent fluid transport surfaces, which convey the fluid under the effect of centrifugal force radially outward in the manner of a pump. In this way, the fluid pressure is increased in the radially outward direction, so that in other areas, that is, for example, in the channels 96 of the more slowly rotating friction elements 64, 66, the fluid is displaced radially inward. The circulation Z, shown in FIG. 1, which flows around the friction elements 60, 62, 64, 66 at comparatively high speed, is obtained. In addition, it is possible to reinforce the fluid exchange by providing a plurality of openings 102 in the abutment ring 64, through which the radially outward-transported fluid can flow away from the area of the friction elements, so that fresh, i.e., somewhat cooler, fluid can enter via the radially inner area. For this purpose, these openings 102 are preferably arranged radially outside the area in which the abutment ring 14 cooperates with the friction elements, that is, outside the effective area of the second friction elements 64, 68.

It is obvious that, in the case of the bridging clutch arrangement 58, especially the friction elements for generating the fluid circulation can be designed differently than described above. It is possible, for example, to provide continuous ring-like friction linings, into which groove-like channels are introduced. It would also be conceivable, especially in combination with the provision of the openings 102, to provide friction linings or fluid transport surfaces on both axial sides of the each of the first friction elements, that is, on both sides of the more rapidly rotating friction elements, which would have the effect of increasing the centrifugally driven transport capacity for the fluid in the radially outward direction and increase the rate at which this fluid is carried away via the openings 102. In this case, there would be essentially only one direction of fluid flow, namely, from the radially inner area toward the radially outer area. Here, too, it is obvious that the friction lining carriers themselves could be designed appropriately to provide fluid transport surfaces, which would cooperate with the fluid transport surfaces on the friction lining arrangements.

In conclusion, it should be pointed out that other areas of the hydrodynamic torque converter 10 can obviously also be designed in ways different from those previously described without departing from the principles of the present invention. For example, the bridging clutch arrangement 58 could be connected to the turbine wheel by way of a torsional vibration damper arrangement.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A hydrodynamic torque converter, comprising:
a housing arrangement (18), which is or can be filled with working fluid;
a pump wheel (30);
a turbine wheel (26), which is mounted in the housing arrangement (18) with freedom to rotate with respect to the housing arrangement (18) around an axis of rotation (A); and
a bridging clutch arrangement (58) for a torque-transmitting connection between the housing arrangement (18) and the turbine wheel (26);
wherein the bridging clutch arrangement (58) has at least one first friction element (60, 62), which can rotate together with the housing arrangement (18), and at least one second friction element (64, 66), which can rotate together with the turbine wheel (26), the first and second friction elements being structured to be brought into frictional contact with each other to provide the torque-transmitting connection; and
wherein at least one of the friction elements (60, 62, 64, 66) is designed to produce a fluid circulation (Z), which flows around at least certain areas of the friction elements (60, 62, 64, 66).

2. A hydrodynamic torque converter according to claim 1, wherein a fluid transport device (98, 100) for producing the fluid circulation is provided on at least one of the friction elements (60, 62, 64, 66).

3. A hydrodynamic torque converter according to claim 2, wherein the fluid transport device comprises at least one fluid transport surface (38, 100).

4. A hydrodynamic torque converter according to claim 1, wherein at least one of the friction elements (60, 62, 64, 66) comprises a friction lining carrier (90) and a friction lining arrangement (92) carried thereon, and in that a minimum of one fluid transport surface (98, 100) is provided by the friction lining arrangement (92).

5. A hydrodynamic torque converter according to claim 4, wherein the friction lining arrangement (92) has a plurality of friction lining segments (94) arranged in the circumferential direction on at least one side of the friction lining carrier (90), and wherein at least one fluid transport surface (98, 100) is provided by a circumferentially-facing end surface of a friction lining segment (94).

6. A hydrodynamic torque converter according to claim 4 wherein the friction lining arrangement (92) has at least one groove-like fluid flow channel (96) extending from the radially outer area toward the radially inner area, and in that at least one fluid transport surface (98, 100) is provided by one of the circumferentially-facing walls forming the boundaries of the minimum of one fluid flow channel (96).

7. A hydrodynamic torque converter according to claim 4 wherein the first and second friction elements (60, 62, 64, 66) are arranged alternately in the axial direction, wherein the first and second friction elements (60, 62, 64, 66) each have a friction lining arrangement (92) on one axial side, where the friction lining arrangements (92) of the first friction elements (60, 62) and the friction lining arrangements (92) of the second friction elements (64, 66) provide fluid transport surfaces (98, 100).

8. A hydrodynamic torque converter according to claim 1 wherein an actuating piston arrangement (84) is provided, by which the first and second friction elements (60, 62, 64, 66) can be brought into frictional contact with each other, and in that the actuating piston arrangement (84) divides an interior space (22) of the housing arrangement (18) into a first space (86), which contains the turbine wheel (26), and a second space (88), to which a pressurized fluid can be supplied to move the piston, wherein the first space (86) and the second space (88) are not in fluid-exchanging connection with each other.
